(19) United States
(12) Patent Application Publication
(10) Pub. No.: US 2016/0156825 A1
(43) Pub. Date: Jun. 2, 2016

(54) OUTDOOR EXPOSURE CONTROL OF STILL IMAGE CAPTURE

(71) Applicant: OMG PLC, Oxford, Oxfordshire (GB)

(72) Inventors: James DALLAS, London (GB); James Alexander LEIGH, London (GB)

(73) Assignee: OMG PLC, Oxfordshire (GB)

(21) Appl. No.: 14/905,850

(22) PCT Filed: Jul. 14, 2014
(86) PCT No.: PCT/GB2014/052142

§ 371 Date: Jan. 18, 2016

(30) Foreign Application Priority Data
Jul. 18, 2013 (GB) 1312893.9

(51) Int. Cl. H04N 5/235

(52) U.S. Cl. CPC H04N 5/2351; H04N 5/2355

(57) ABSTRACT

A camera unit that captures still images determines whether the camera unit is outdoors or indoors, and in dependence on that an exposure mask of weights in respect of areas of an image to be an outdoor or indoor exposure mask is selected. The outdoor exposure mask has weights in respect of areas of the image corresponding to a lower region of a scene being imaged and weights in respect of areas of the image corresponding to an upper region of a scene being imaged in a ratio that is greater than the corresponding ratio in the indoor exposure mask. A brightness measure of the overall brightness of captured images is derived from the brightness of areas of the images weighted by the selected exposure mask. The exposure of captured images is controlled in dependence on the brightness measures of previously captured images.

The present invention relates to exposure control of a camera unit that comprises an image sensor that is operated to capture still images.

Image capture by a camera unit can occur in a variety of lighting conditions. Since any image sensor has a limited dynamic range, the exposure of the image sensor needs to be controlled to accommodate the variation in illumination. Much development of automatic exposure control has occurred.

One known approach to automatic exposure control is as follows. Successive images are captured in a cycle and a brightness measure of the overall brightness of each captured image is derived. The exposure of captured images may then be controlled in dependence on the brightness measures of previously captured images. For example, the exposure of captured images may be controlled to drive the brightness measure towards a target level. When the exposure has converged, the final captured image is stored. The other captured images are discarded on the basis of having sub-optimal exposure.

Control of exposure tends to be particularly difficult outdoors, in which case images often contain a high degree of contrast between areas which are very bright, such as sky, and areas which are dark, such as a foreground in shadow. In situations of this type it is intrinsically difficult to correctly expose the image as the ideal exposures for the bright and dark areas may be different. Often this situation can cause automatic exposure control to under-expose the dark areas of an image, sometimes severely, as the bright area dominates the response of the control and the dynamic range of the image sensor cannot effectively capture both the bright and the dark areas.

Most still digital camera images are taken while the camera unit is stationary, with a user pointing the camera unit, framing the shot, checking the image quality in a preview mode, and altering the camera direction, framing, or other settings such as exposure until they have a satisfactory shot. Even in this situation, the problems associated with outdoor image capture discussed above are present.

However, these problems are exacerbated in the case of a camera unit that comprises a control circuit that controls the image sensor to capture images intermittently without a user triggering capture of the individual images. Such a camera unit may, for example, capture images in response to sensors that sense physical parameters of the camera unit or its surroundings. That allows for intelligent decisions on the timing of image captures, in a way that increases the chances of the images being of scenes that are significant to the user. In general, since the camera unit captures images without a user triggering capture, the user does not know the intermittent times at which image capture will occur. Thus, there is a greater chance of the camera unit being directed at a scene that is difficult to expose correctly and there is no possibility of the user taking any positive action to correct or improve exposure.

Furthermore, such a camera unit might typically have a relatively wide field of view. This is to compensate for the fact that the camera unit will typically not be directed at a scene that has a natural point of interest since the user does not know when image capture will occur. However, such a wide field of view increases the chances of a situation where the scene being imaged has a greater dynamic range than the image sensor, which may be a small image sensor suited to a wearable device.

Some existing approaches for dealing with this issue are as follows.

One approach is to use sensors having an increased dynamic range. However, such sensors tend to be larger and more expensive. This is acceptable for DSLR cameras, but not acceptable for a small, reasonably priced, low power camera unit, as may be used for example in an automatically triggered camera.

Another approach is to use HDR (High Dynamic Range) imaging which is an exposure bracketing technique in which several images of the same subject are captured with different exposures and the images combined to form a composite image with increased dynamic range. However, this approach only works if the camera unit is kept sufficiently still between image captures, which might not be the case for many applications, for example in an automatically triggered camera unit because in that case the user is unaware that image capture is to occur.

Another approach is to use a user-driven exposure technique based on user input, for example identifying on a screen the part of the image desired to be exposed, or otherwise manually intervening in the automatic exposure control to change the exposure. Again, this is not suitable for many applications for example in an automatically triggered camera unit because the user is unaware that image capture is to occur.

An additional point is that the issues are more difficult for still images than for video images. This is because video cameras tend to converge to the correct exposure over time as the lighting context changes. In contrast, individual still images tend to be viewed for a longer time and so the perceived quality threshold may be higher than video.

The present invention is concerned with tackling this issue.

According to the present invention, there is provided a method of controlling a camera unit that comprises an image sensor arranged to capture images, the method comprising:
making a determination of whether the camera unit is outdoors or indoors;
selecting an exposure mask of weights in respect of areas of an image to be an outdoor or indoor exposure mask in dependence on the determination that the camera unit is outdoors or indoors, wherein the outdoor exposure mask has weights in respect of areas of the image corresponding to a lower region of a scene being imaged and weights in respect of areas of the image corresponding to an upper region of a scene being imaged in a ratio that is greater than the corresponding ratio in the indoor exposure mask;
capturing still images;
deriving a brightness measure of the overall brightness of captured images from the brightness of areas of the images weighted by the selected exposure mask, the exposure of captured images being controlled in dependence on the brightness measures of previously captured images.

The present invention makes use of a determination of whether the camera unit is outdoors or indoors to provide an overall improvement of the control of exposure when the camera unit is outdoors, without compromising the indoor performance. This is achieved by selection of an outdoor or indoor exposure mask in dependence on the determination. Such an exposure mask comprises weights in respect of areas of an image that are used to weight the brightness of areas of captured images in deriving a brightness measure that represents the overall brightness of the image. As separate outdoor or indoor exposure masks may be selected, these may be optimised for the likely illumination of indoor and outdoor scenes being imaged.

In particular, the weights in respect of areas of the image corresponding to a lower region of a scene being imaged and the weights in respect of areas of the image corresponding to an upper region of a scene being imaged may have a greater ratio in the outdoor exposure mask than in the indoor exposure mask. This allows the outdoor exposure mask to be biased towards areas of the image corresponding to a lower region of a scene being imaged. Thus the exposure control tends to bias the response of the exposure control on those lower regions of the scene. Generally an image of an outdoor scene will tend to be bright in its upper regions, which may for example be sky, and dark in its lower regions, which may for example be a foreground that is less illuminated. As a result, it is more likely that the region which is likely to be a foreground of interest to the user is correctly exposed. This is at the expense of increasing the likelihood of over-exposing the region likely to be sky, but that is more likely to be acceptable to a user than an under-exposed foreground. Hence the image quality is improved overall.

The method may be applied by capturing images and deriving a brightness measure repeatedly in a cycle to converge the exposure. In that case, the exposure of captured images may be controlled to drive the brightness measure towards a target level. One of the images captured during the cycle is stored and the others are discarded. The stored image may be the final image captured during the cycle, although that is not essential and another image may be stored on the basis of some other criteria.

The present invention has particular advantage when applied to a camera unit in which the method is performed intermittently without triggering by a user, for example a camera unit that comprises plural sensors arranged to sense physical parameters of the camera unit or its surroundings, in which case the method may performed intermittently in response to the outputs of the sensors. As discussed above, in such a camera unit there is a greater likelihood of the camera being directed at a scene that is difficult to expose correctly, and hence the advantage becomes more significant.

In the case that the camera unit comprises an orientation sensor arranged to detect the orientation of the camera unit, the method may further comprise, when the determination is made that the camera unit is outdoors, determining the areas of the image corresponding to the upper and lower region of a scene being imaged on the basis of the detected orientation of the camera unit, and the outdoor exposure mask having said weights in respect of the areas of the image corresponding to the lower region of a scene being imaged, as so determined, and weights in respect of the areas of the image corresponding to an upper region of a scene being imaged, as so determined.

In this manner, the areas of the image corresponding to upper and lower regions of the scene may be derived from the detected orientation. This allows the method to accommodate the camera unit being in different orientations, and therefore improves the likelihood of beneficial results. However, this is not essential. Since the camera unit will have a typical orientation in normal use, benefits may still be obtained from application of the method with the upper and lower areas of the image being taken to correspond to the upper and lower regions of the scene being imaged, in accordance with the typical orientation of the camera.

The determination of whether the camera unit is outdoors or indoors may be performed on the basis of the level of ambient light detected by a light sensor. In that case it may be assumed that high ambient light is indicative of the camera unit being outdoors. However, it is not essential to use a light sensor and instead the determination could be made on the basis of analysis of a captured image, for example on the basis of the brightness measure of a captured image, taking account of the exposure of that captured image.

Further according to the present invention, there is provided a camera unit comprising an image sensor and a control circuit for controlling the camera unit that is arranged to perform an image capture operation similar to the method. An embodiment of the present invention will now be described by way of non-limitative example with reference to the accompanying drawings, in which:

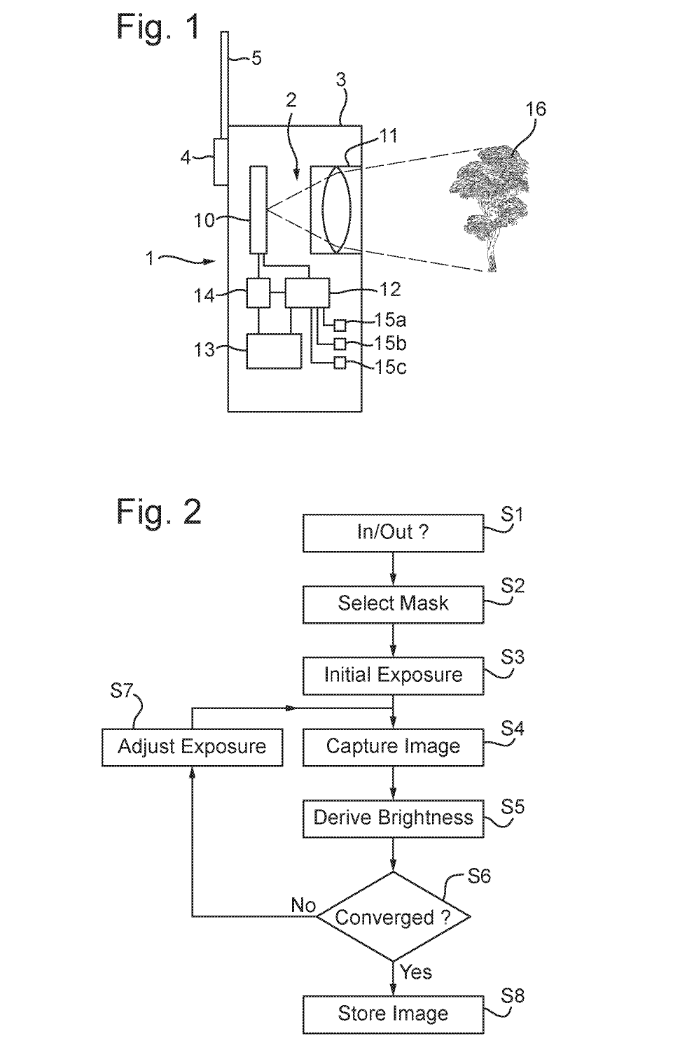

FIG. 1 is a schematic block diagram of a camera;

FIG. 2 is a flow chart of an image capture operation performed in the camera of FIG. 1;

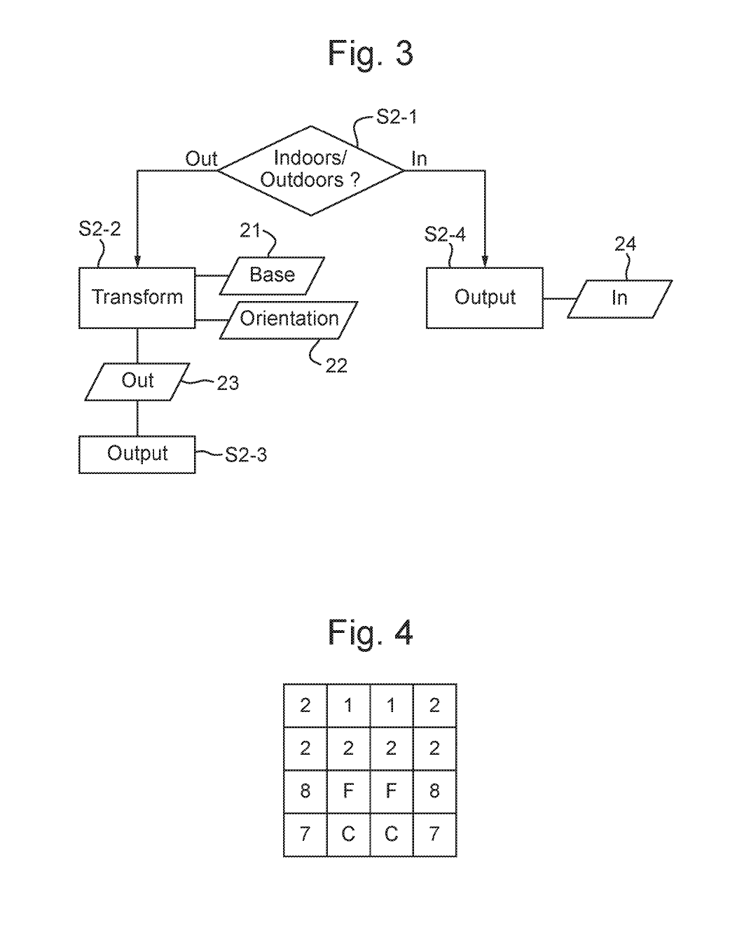

FIG. 3 is a flow chart of the step of selecting an exposure mask in the method of FIG. 2; and

FIG. 4 shows an example outdoor exposure mask.

FIG. 1 is schematic block diagram of a camera 1 comprising a camera unit 2 mounted in a housing 3. To make the camera 1 wearable, the housing 3 has a fitment 4 to which is attached a lanyard 5 that may be placed around a user's neck. Other means for wearing the camera 1 could be provided, for example a clip to allow attachment to a user's clothing.

The camera unit 2 comprises an image sensor 10 and a camera lens assembly 11 in front face of the housing 13. The camera lens assembly 11 focuses an image of a scene 16 on the image sensor 10 which captures the image and may be of any suitable type for example a CMOS (complimentary metal-oxide-semiconductor) device. The camera lens assembly 11 may include any number of lenses and may provide a fixed focus that preferably has a wide field of view.

The size of the image sensor 10 has a consequential effect on the size of the other components and hence the camera unit 2 as a whole. In general, the image sensor 10 may be of any size, but since the camera 1 is to be worn, the image sensor 10 is typically relatively small. For example, the image sensor 10 may typically have a diagonal of 6.00 mm (corresponding to a ⅓″ format image sensor) or less, or more preferably 5.68 mm (corresponding to a 1/3.2″ format image sensor) or less. In one implementation, the image sensor has 5 megapixels in a 2592-by-1944 array in a standard 1/3.2″ format with 1.75 μm square pixels, producing an 8-bit raw RGB Bayer output, having an exposure of the order of milliseconds and an analogue gain multiplier

In normal use, the camera unit 2 will be directed generally in the same direction as the user, but might not be directed at a scene that has a natural point of interest since the user does not know when image capture will occur. For this reason, it is desirable that the camera lens assembly 11 has a relatively wide field of view (“wide angle”). For example, the camera lens assembly 11 may typically have a diagonal field of view of 85 degrees or more, or more preferably 100 degrees or more.

The camera unit 2 includes a control circuit 12 that controls the entire camera unit 2. The control circuit 12 controls the image sensor 10 to capture still images that may be stored in a memory 13. The control circuit 12 may be implemented by a processor running an appropriate program. The control circuit 12 may include conventional elements to control the parameters of operation of the image sensor 10 such as exposure time. Similarly, the memory 13 may take any suitable form, a non-limitative example being a flash memory that may be integrated or provided in a removable card.

A buffer 14 is included to buffer captured images prior to permanent storage in the memory 13. The buffer 14 may an integrated element separate from the memory 13, or may be a region of the memory 13 selected by the control circuit 12.

The camera unit 2 further includes plural sensors 15 that sense different physical parameters of the camera unit 2 or its surroundings (three sensors 15 being shown in FIG. 1 for illustration, although any number may be provided).

The sensors 15 include an orientation sensor 15a that detects the orientation of the camera unit. This may be implemented by a gyroscope sensor and/or accelerometer that may similarly detect linear and/or rotational speed and/or acceleration of the camera unit 2.

The sensors 15 include a light sensor 15b that detects the level of ambient light.

Other non-limitative examples of the types of sensing and sensors 15 include: sensing of location of the camera unit 2 for example using a GPS (global positioning system) receiver; for example using a gyroscope sensor and/or accelerometer; sensing of magnetic fields using a magnetometer; sensing of motion of external objects using an external motion sensor, that may be for example an infra-red motion sensor; sensing of temperature using a thermometer; and sensing of sound.

Alternatively, the control circuit 12 may perform the image capture operation intermittently based on the time taken since the previous image capture.

The control circuit 12 may perform the image capture operation intermittently in response to the outputs of the sensors 15. This allows the images to be captured without capture of individual images being triggered by the user. Capture of images may be triggered when the outputs of the sensors 15 indicate a change or a high level on the basis that this suggests occurrence of an event that might be of significance to the user. Capture may be triggered based on a single sensor or a combination of sensors 15. That allows for intelligent decisions on the timing of image captures, in a way that increases the chances of the images being of scenes that are in fact significant to the user. Images are captured intermittently over a period of time, for example by capturing an image when the period since the last capture exceeds a limit, or by over time reducing the thresholds on the outputs of the sensors used for triggering. Thus, the user does not generally know when image capture will occur and so will not be taking any specific action to improve image quality.

Alternatively, the control circuit 12 may perform the image capture operation intermittently based on the time taken since the previous image capture so that the images are taken a predetermined rate.

The image capture operation performed by the control circuit 12 is shown in FIG. 2 and performed as follows. The image capture operation implements exposure control by capturing images repeatedly in a cycle and selecting one of those images for storage in the memory 13.

In step S1, a determination is made of whether the camera unit 2 is outdoors or indoors. This determination is made on the basis of the level of ambient light detected by the light sensor 15b, for example by determining the camera unit 2 to be outdoors when detected level exceeds a threshold (optionally applying a hysteresis band to change the threshold depending on a previous determination), and determining the camera unit 2 to be indoors otherwise. Of course this determination might not always be correct, but in general the degree of ambient light is a good indicator of whether the camera unit 2 is indoors or outdoors.

In step S2, an exposure mask is selected to be an outdoor or indoor exposure mask in dependence on the determination made in step S1 that the camera is outdoors or indoors. Such an exposure mask comprises weights in respect of areas of an image. As described further below, the exposure mask is used to weight the brightness of areas of a captured image to derive a brightness measure representative of the overall brightness of the image. The exposure mask may in general correspond to any number of areas of the image in any pattern. One possible format for the exposure mask is for the weights to correspond to an N-by-N array of rectangular areas, where N may be 4 to provide 16 areas.

Step S2 is shown in more detail in FIG. 3, and comprises the following steps. In step S2-1, the determination made in step S1 is checked. In the case that the determination is that the camera unit 2 is outdoors, the outdoor exposure mask is selected in steps S2-2 and S2-3 as follows.

The outdoor exposure mask has different weights corresponding to different areas of the image. This causes the response of the exposure control to be biased towards areas which have a relatively high weight, causing those areas to be more correctly exposed, at the expense of areas having a relatively low weight to be less correctly exposed.

The outdoor exposure mask is based on the following assumptions that are generally correct, notwithstanding variation from image to image.

A first assumption is that a scene 16 that is outdoors is strongly lit from above, and so the upper regions of the scene 16 are bright, for example sky or direct sunlight, and the lower regions of the scene 16 are dark, for example a foreground. The outdoor exposure mask further assumes that, given a limited dynamic range of the image sensor 10, a user will find it more acceptable for the dark areas to be correctly exposed at the expense of the bright areas than vice versa. This is because in general the dark areas are more likely to be a foreground containing an object of interest and the bright areas are more likely to be sky. Therefore the outdoor exposure mask has weights in respect of areas of the image corresponding to a lower region of the scene 16 that are greater than the weights in respect of areas of the image corresponding to an upper region of the scene 16.

A second assumption is that a scene 16 that is outdoors is more likely in the upper region of the scene 16 to be brighter lit in the centre than the edges, for example with the sun in the centre of the image or a “canyon” scene such as a street with buildings on the side. Therefore the outdoor exposure mask has weights in respect of areas of the image corresponding to an upper region of the scene 16 that are lower in a central part of the upper region that in the outer parts of the upper region.

A third assumption is that a scene 16 that is outdoors is more likely in the lower region of the scene 16 to have an object of interest to the user a central part of the lower region that in the outer parts of the lower region. Therefore, the outdoor exposure mask has weights in respect of areas of the image corresponding to the lower region of the scene 16 that are higher in a central part of the lower region that in the outer parts of the lower region.

FIG. 4 shows an example of an outdoor exposure mask corresponding to a 4-by-4 array of rectangular areas that is based on these assumptions, and for the case that the optical axis is horizontal and that the orientation of the image is aligned with the orientation of the scene 16 being imaged. The weights in this example have been shown to be suitable based on simulation and experimentation, but other values of the weights are possible.

It may be assumed that the camera unit 2 will have a typical orientation in normal use in which the orientation of the image is aligned with the orientation of the scene 16 being imaged. This may be generally true, particularly if the means for wearing the camera 1 tend to orient the camera 1 in particular direction, as is the case with the lanyard 5. In that case the same outdoor exposure mask may always be selected, for example to be the outdoor exposure mask shown in FIG. 4.

Whilst that approach may be beneficial overall, the actual orientation of the camera unit 2 may vary in use, particularly in the case that the camera 1 may be worn in different orientations for example clipped sideways or upside down, and may vary as the user moves. As the outdoor exposure mask is not rotationally symmetric, and assumes a horizon at roughly the middle, improved performance can be achieved by compensating for rotation and tilt.

For this purpose, steps S2-2 and S2-3 may be performed to adapt the outdoor exposure mask to the actual orientation of the camera unit 2. These steps transform a base outdoor exposure mask 21 corresponding to an assumed orientation of the image being aligned with the orientation of the scene 16 being imaged. The base outdoor exposure mask 21 may be for example the outdoor exposure mask shown in FIG. 4.

Step S2-2 also uses the orientation 22 of the camera unit 2 detected by the orientation sensor 15a, in particular the pitch and roll of the camera unit 2. In this context, pitch and roll having their normal meanings as follows. Pitch is the orientation about the optical axis of the camera unit 2. Roll is the orientation about an axis that is horizontal (relative to the earth) and perpendicular to the optical axis of the camera unit 2. The pitch and roll effectively provide a determination of the areas of the image corresponding to upper and lower regions of the scene 16.

Yaw may also be detected by the orientation sensor 15a, but is not used here since yaw does not affect which areas of the image corresponding to upper and lower regions of the scene 16.

In step S2-2, the base outdoor exposure mask 21 is transformed on the basis of the detected orientation 22. This corrects the assumed orientation to the detected orientation 22.

The base outdoor exposure mask 21 may be translated vertically in on the basis of the pitch. This may involve interpolating values proportionately, and applying specific top and bottom fill values to back fill empty weights.

The base outdoor exposure mask 21 may be rotated in on the basis of the roll. Rotation may be applied on increments of 90% or any other value. This may involve interpolating values proportionately Step S2-2 derives the selected outdoor exposure mask 23.

In step S2-3, the selected outdoor exposure mask 23 is output.

In the case that the determination in step S2-1 is that the camera unit 2 is indoors, in step S2-4, an indoor exposure mask 24 is output.

The indoor exposure mask 24 in this example is a flat mask having equal weights. Therefore the weights in respect of areas of the image corresponding to a lower region of the scene 16 have the same value as the weights in respect of areas of the image corresponding to an upper region of the scene 16. Compared to the outdoor exposure mask 23, the ration of the weights in these regions is lower.

As an alternative, the indoor exposure mask could be modified to have different weights corresponding to different areas of the image. This could occur in a similar manner to the outdoor exposure mask as in steps S2-2 and S2-3 described above. For example, the indoor exposure mask could be based on assumptions that a scene 16 that is indoors is lit from above and that objects of interest in a scene 16 that is indoors are typically in the central area. However, even if the weights in respect of areas of the image corresponding to a upper and lower regions of the scene 16 have different values, since ratio of those weights remains lower than the corresponding ratio in the outdoor exposure mask, because the variation in brightness will be significantly less indoors than outdoors.

After selection of an exposure mask in step S2, in step S3 an initial value is selected for the image capture operation in step S4. The exposure is controlled by varying the exposure period and the exposure gain of the image sensor 10. Generally exposure can also be controlled by variation of aperture size, but in the present camera 1 the lens assembly 11 has a simple design with a fixed aperture size.

In step S4, a still image is captured. During the image capture, the exposure is controlled to be the value for the exposure selected in step S3 for the image captured in the initial performance of step S4, and adjusted in step S7 for the images captured in the subsequent performance of step S4, as described below. The captured images are stored in the buffer 14.

In step S5, a brightness measure of the overall brightness of the captured image is derived from the brightness of areas of the captured image weighted by the exposure mask selected in step S2. In this manner, the exposure mask affects the brightness measure. The brightness may be measured by the luminance of the image or any other type of brightness measure.

In step S6, the brightness measure is compared to a target level to determine if the exposure has converged to bring the brightness measure to the target level. If not then the method returns via step S7 to capture another image in step S4. In step S7, the value for the exposure is adjusted to drive the brightness measure for the subsequently captured image towards a target level. The difference between the brightness measure from step S6 and the target level is used as a feedback parameter for this adjustment. In this manner, step S4 is performed repeatedly to capture images in a cycle with the exposure of the captured images being controlled in dependence on the brightness measures of previously captured images determined in step S5.

The buffer 14 may temporarily buffer all the images captured in the cycle, or in the case that it has a limited size, may temporarily buffer a single image, or a group of two or more images, captured most recently.

When it is determined in step S6 that the exposure has converged to bring the brightness measure to the target level, the method proceeds to step S8 in which one of the images captured during the cycle and buffered in the buffer 14 is stored in the memory 13. The other images captured during the cycle are discarded. The captured image stored in the memory 13 may be the final image captured during the cycle, although in the case that the buffer 14 buffers a group of images it could in principle be one of the other images in the buffer 14.

1. A method of controlling a camera unit that comprises an image sensor arranged to capture images, the method comprising:
making a determination of whether the camera unit is outdoors or indoors;
selecting an exposure mask of weights in respect of areas of an image to be an outdoor or indoor exposure mask in dependence on the determination that the camera unit is outdoors or indoors, wherein the outdoor exposure mask has weights in respect of areas of the image corresponding to a lower region of a scene being imaged and weights in respect of areas of the image corresponding to an upper region of a scene being imaged in a ratio that is greater than the corresponding ratio in the indoor exposure mask;
capturing still images;
deriving a brightness measure of the overall brightness of captured images from the brightness of areas of the images weighted by the selected exposure mask, the exposure of captured images being controlled in dependence on the brightness measures of previously captured images.

2. A method according to claim 1, wherein
the camera unit comprises an orientation sensor arranged to detect the orientation of the camera unit,
the method further comprises, when the determination is made that the camera unit is outdoors, determining the areas of the image corresponding to the upper and lower region of a scene being imaged on the basis of the detected orientation of the camera unit, and the outdoor exposure mask having said weights in respect of the areas of the image corresponding to the lower region of a scene being imaged, as so determined, and weights in respect of the areas of the image corresponding to an upper region of a scene being imaged, as so determined.

3. A method according to claim 2, wherein the step of determining the areas of the image corresponding to the upper and lower region of a scene being imaged takes account of the pitch of the camera unit.

4. A method according to claim 2, wherein the step of determining the areas of the image corresponding to the upper and lower region of a scene being imaged takes account of the roll of the camera unit.

5. A method according to claim 1, wherein the steps of capturing images and deriving a brightness measure are performed repeatedly in a cycle, the exposure of captured images being controlled to drive the brightness measure towards a target level, and the method further comprises storing one of the images captured during the cycle and discarding the other images captured during the cycle.

6. A method according to claim 5, wherein the one of the images captured during the cycle that is stored is the final image captured during the cycle.

7. A method according to claim 1, wherein the method is performed intermittently without triggering by a user.

8. A method according to claim 7, wherein the camera unit comprises plural sensors arranged to sense physical parameters of the camera unit or its surroundings, and the method is performed intermittently in response to the outputs of the sensors.

9. A method according to claim 1, wherein the camera unit comprises a light sensor arranged to detect a level of ambient light, and the step of making a determination of whether the camera unit is outdoors or indoors is performed on the basis of the level of ambient light detected by the light sensor.

10. A method according to claim 1, wherein the indoor exposure mask has equal weights.

11. A method according to claim 1, wherein the outdoor exposure mask has weights in respect of areas of the image corresponding to the lower region of a scene being imaged that are higher in a central part of the lower region that in the outer parts of the lower region.

12. A method according to claim 1, wherein the outdoor exposure mask has weights in respect of areas of the image corresponding to an upper region of a scene being imaged that are lower in a central part of the upper region that in the outer parts of the lower region.

13. (canceled)

14. A camera unit comprising:
an image sensor
a control circuit for controlling the camera unit, the control circuit being arranged to perform an image capture operation comprising:
making a determination of whether the camera unit is outdoors or indoors;
selecting an exposure mask of weights in respect of areas of an image to be an outdoor or indoor exposure mask in dependence on the determination that the camera unit is outdoors or indoors, wherein the outdoor exposure mask has weights in respect of areas of the image corresponding to a lower region of a scene being imaged and weights in respect of areas of the image corresponding to an upper region of a scene being imaged in a ratio that is greater than the corresponding ratio in the indoor exposure mask;
capturing still images;
deriving a brightness measure of the overall brightness of captured images from the brightness of areas of the images weighted by the selected exposure mask, the exposure of captured images being controlled in dependence on the brightness measures of previously captured images.

15. A camera unit according to claim 14, wherein
the camera unit further comprises an orientation sensor arranged to detect the orientation of the camera unit,
the image capture operation further comprises, when the determination is made that the camera unit is outdoors, determining the areas of the image corresponding to the upper and lower region of a scene being imaged on the basis of the detected orientation of the camera unit, and the outdoor exposure mask having said weights in respect of the areas of the image corresponding to the lower region of a scene being imaged, as so determined, and weights in respect of the areas of the image corresponding to an upper region of a scene being imaged, as so determined.

16. A camera unit according to claim 15, wherein the determining of the areas of the image corresponding to the upper and lower region of a scene being imaged takes account of the pitch of the camera unit.

17. A camera unit according to claim 15, wherein the determining of the areas of the image corresponding to the upper and lower region of a scene being imaged takes account of the roll of the camera unit.

18. A camera unit according to claim 14, wherein the control circuit is arranged to perform the capturing of images and deriving of a brightness measure repeatedly in a cycle, the exposure of captured images being controlled to drive the brightness measure towards a target level, to store one of the images captured during the cycle and to discard the other images captured during the cycle.

19. A camera unit according to claim 18, wherein the one of the images captured during the cycle that is stored is the final image captured during the cycle.

20. A camera unit according to claim 18, wherein the control circuit is arranged to perform the image capture operation intermittently without being triggering by a user.

21. A camera unit according to claim 20, wherein the camera unit comprises plural sensors arranged to sense physical parameters of the camera unit or its surroundings, and the control circuit is arranged to perform the image capture operation intermittently in response to the outputs of the sensors.

22. A camera unit according to claim 14, wherein the camera unit comprises a light sensor arranged to detect a level of ambient light, and the making of a determination of whether the camera unit is outdoors or indoors is performed on the basis of the level of ambient light detected by the light sensor.

23. A camera unit according to claim 14, wherein the indoor exposure mask has equal weights.

24. A camera unit according to claim 14, wherein the outdoor exposure mask has weights in respect of areas of the image corresponding to the lower region of a scene being imaged that are higher in a central part of the lower region that in the outer parts of the lower region.

25. A camera unit according to claim 14, wherein the outdoor exposure mask has weights in respect of areas of the image corresponding to an upper region of a scene being imaged that are lower in a central part of the upper region that in the outer parts of the lower region.

26. A camera comprising a housing and a camera unit according to claim 14 mounted in a housing.
